(19) United States
(12) Patent Application Publication
(10) Pub. No.: US 2008/0100242 A1
(43) Pub. Date: May 1, 2008

(54) Motor Drive Circuit and Motor Apparatus Including the Same

(76) Inventor: Seiichi Yamamoto, Kyoto (JP)

Correspondence Address: FISH & RICHARDSON P.C.;Citigroup Center, 153 East 53rd Street, 52nd floor, New York, NY, 10022-4611, US

(21) Appl. No.: 11/662,615

(22) PCT Filed: Oct. 3, 2005
(86) PCT No.: PCT/JP05/18267

§ 371 Date: Mar. 12, 2007

(30) Foreign Application Priority Data
Oct. 8, 2004 (JP) 2004-296967

(51) Int. Cl. H02P 3/14; H02P 7/28

(52) U.S. Cl. 318/376

(57) ABSTRACT

A motor drive circuit (3) includes a plurality of pairs of a power-supply-side drive transistor (15, 16) and a ground-side drive transistor (17, 18) that drive a coil (9) from a midpoint thereof, a drive current detecting unit (19) that detects a drive current of coil (9) on the power supply side, and a control circuit (20) that controls such that in the case where the motor rotating in a positive direction is braked, in order to apply a torque in a negative direction, selects the power-supply-side drive transistor and the other ground-side drive transistor and turns on to flow the drive current, and when the drive current becomes a predetermined value, turns off these selected power-supply-side drive transistor and selected ground-side drive transistor to flow a regenerative current. Accordingly, the motor drive circuit that can control the torque in the case where the torque in the negative direction is applied to the motor rotating in the positive direction to brake can be provided.

### TECHNICAL FIELD

The present invention relates to a motor drive circuit in which voltage is applied to a coil of a motor (including an actuator) by PWM (pulse width modulation), and a motor apparatus including the same.

### BACKGROUND ART

Conventionally, there has been known a PWM-driven motor apparatus in which a torque of the motor is controlled by applying a voltage at a power supply voltage level to a coil only in a pulse period of PWM, that is, in an on-duty period (for example, refer to Japanese Patent Laying-Open No. 2004-015855 (Patent Document 1)). In this motor apparatus, a drive current flows into ground potential from power supply potential through the coil in the pulse period of PWM (hereinafter, referred to as a drive period TD), and in the rest of period, that is, in an off-duty period (hereinafter, referred to as a regenerative period TE), a regenerative current flows in a path different from a path in drive period TD by inductivity of the coil causing the current to continue to flow. FIG. 4 is a circuit diagram showing one example of this type of conventional motor apparatus. This motor apparatus 101 is composed of a motor 102 having a coil 109, and a motor drive circuit 103 that drives a motor 102.

Motor drive circuit 103 is controlled by a torque control voltage TO and a reference voltage REF inputted from an instructing unit (not shown) such as an external microcomputer. That is, in the case where motor 102 is activated to be rotated at a constant speed in a positive direction, torque control voltage TO inputted through a torque-control-voltage input terminal 110 becomes higher than reference voltage REF inputted through a reference-voltage input terminal 111. Therefore, the output of a polarity comparator 126 becomes a high level, and a power-supply-side drive transistor 116 is turned off through a control logic circuit 127. When a clock CLK from an oscillator (OSC) 125 rises, and the output of a flip-flop 124 becomes a high level, a ground-side drive transistor 117 is turned off, and a power-supply-side drive transistor 115 and a ground-side drive transistor 118 are turned on. A drive current ID flows from a drive input terminal A toward a drive input terminal B in coil 109 of motor 102. Drive current ID gradually increases. In a resistance element 119, which is a drive current detecting unit, a voltage in proportion to this drive current I_{D} is generated. An absolute-value output device 121 outputs an absolute value of a difference between torque control voltage TO and reference voltage REF. A variable voltage is outputted from a variable voltage generator 122 controlled by absolute-value output device 121. When the voltage in proportion to drive current I_{D} becomes larger than the variable voltage, the output of a drive-current detection comparator 123 becomes a high level, and the output of flip-flop 124 becomes a low level. Consequently, power-supply-side drive transistor 115 is turned off and at the same time, ground-side drive transistor 117 is turned on, and a regenerative current I_{E} flows from drive input terminal A toward drive input terminal B in coil 109. Regenerative current I_{E} gradually decreases.

In this manner, drive current I_{D} increasing gradually and regenerative current I_{E} decreasing gradually flow repeatedly in coil 109 and a maximum value of drive current I_{D} is controlled, by which the torque of motor 102 is controlled. In this case, when regenerative current I_{E} flows, ground-side drive transistors 117, 118 are both turned on, and drive input terminals A, B are fixed to almost the ground potential. This is intended to inhibit the energy accumulated in coil 109 from being converted into thermal energy and consumed by another element by substantially shorting both ends of coil 109, thereby preventing electric power efficiency from decreasing.

While in this motor drive circuit 103, resistance element 119 is used as a drive current detecting unit, utilizing an on-resistance of the power-supply-side drive transistor or the ground-side drive transistor (for example, refer to Japanese Patent Laying-Open No. 2001-045765 (Patent Document 2)) or the like can also make it unnecessary to use the resistance element as the drive current detecting unit.

Patent Document 1: Japanese Patent Laying-Open No. 2004-015855

Patent Document 2: Japanese Patent Laying-Open No. 2001-045765

### DISCLOSURE OF THE INVENTION

### Problems to be Solved by the Invention

In the case where the motor rotating at a constant speed in the positive direction is decelerated to another desired rotary speed, if a torque in the negative direction is applied to brake (reverse brake), a time until the desired rotary speed is reached is shortened. Accordingly, this method is very effective to a motor apparatus of a system requiring a high-speed operation.

FIGS. 5A to 5E are explanatory diagrams in the case where a torque in the negative direction is applied to brake in motor drive circuit 103. FIGS. 5A, SC are diagrams showing on/off states of drive transistors 115 to 118 in drive period TD, and in regenerative period TE, respectively, FIGS. 5B, 5D are diagrams showing voltage distribution of respective components of coil 109 in drive period TD and regenerative period TE, respectively, and FIG. 5E is a chart showing voltages and current waveforms of respective signals of FIGS. 5A to 5D. CLK indicates a voltage of clock CLK from oscillator 125, A, B indicate voltages of drive input terminals A, B, and with a direction from drive input terminal A to drive input terminal B defined as positive, I₁ indicates a current flowing in coil 109 (that is, a current obtained by adding drive current ID and regenerative current IE) and I₂ indicates a current flowing in resistance element 119. In drive period TD, power-supply-side drive transistor 116 and ground-side drive transistor 117 are turned on, and the voltage of drive input terminal B becomes higher than the voltage of drive input terminal A. In coil 109, contrary to the case where motor 102 is activated to be rotated at the constant speed in the positive direction, drive current I_{D} flows from drive input terminal B to drive input terminal A. As a result, motor 102 is decelerated by the torque in the negative direction. By the rotation of motor 102, a counter electromotive voltage Vₓ is induced in coil 109, depending on the speed and the rotation direction. At this time, as shown in FIG. 5B, counter electromotive current Vₓ is generated in the same direction as drive current I_{D}, that is, from drive input terminal B to drive input terminal A.

In regenerative period TE, since power-supply-side drive transistor 116 is turned off, and ground-side drive transistor 118 is turned on, drive input terminals A, B both almost reach the ground potential, and are substantially shorted. At this time, in coil 109, regenerative current I_{E} flows from drive input terminal B to drive input terminal A, and counter electromotive voltage Vₓ by rotation is generated in the same direction as regenerative current I_{E} as in drive period TD. In this case, it should be noted that while as shown in FIG. 5D, counter electromotive voltage Vₓ by the rotation of motor 102 is offset by a drop voltage V_{R} by the resistance component and a counter electromotive current V₁ by an inductor component, regenerative current I_{E} continues to increase until it reaches Vₓ/Rm. Rm indicates a value of the resistance component.

Accordingly, since after target drive current I_{D} can be detected in resistance element 119 (a time t₀), regenerative current I_{E} does not decrease, drive period TD when drive current I_{D} flows becomes very short, and the current flowing in coil 109 will continue to increase by regenerative current I_{E}. As a result, motor 102 is decelerated by an excessive torque in the negative direction, so that the speed becomes lower than the desired rotary speed. In this case, the instructing unit (not shown) such as the microcomputer or the like can adjust the speed by making torque control voltage TO higher than reference voltage REF again. However, as described above, while the torque in the negative direction is applied, motor drive circuit 3 does not perform the operation of controlling the torque in accordance with torque control voltage TO. Accordingly, the time until motor 102 finally reaches the desired rotary speed becomes long. Moreover, wasteful power is consumed in the meantime.

The present invention is made in light of the above-described situation, and its object is to provide a motor drive circuit capable of controlling a torque in a negative direction, even when the torque in the negative direction is applied to a motor rotating at a constant speed in a positive direction to brake.

### Means for Solving the Problems

The present invention is, in summary, a motor drive circuit controlling a torque of a motor by flowing, through a coil, a drive current increasing gradually and a regenerative current decreasing gradually in accordance with an inputted torque control voltage, including a plurality of pairs of a power-supply-side drive transistor and a ground-side drive transistors, a drive current detecting unit, and a control circuit. The plurality of pairs of the power-supply-side drive transistor and the ground-side drive transistor are connected in series between a power supply potential and a ground potential, and drive the coil connected at a midpoint. The drive current detecting unit detects the drive current of the coil on the power supply side. In the case where the motor is activated to be rotated at a constant speed in a positive direction, the control circuit turns on one power-supply-side drive transistor and one ground-side drive transistor selected from the plurality of pairs of the power-supply-side drive transistor and the ground-side drive transistor to flow the drive current and thereby apply the torque in the positive direction. When the drive current becomes a value corresponding to the torque control voltage, the control circuit turns off the one power-supply-side drive transistor and turns on the ground-side drive transistor paired with the one power-supply-side drive transistor to flow the regenerative current. In the case where the motor rotating in the positive direction is braked, the control circuit turns on the other power-supply-side drive transistor and the other ground-side drive transistor selected from the plurality of pairs of the power-supply-side drive transistor and the ground-side drive transistor to flow the drive current and thereby apply the torque in a negative direction. When the drive current becomes a value corresponding to the torque control voltage, the control circuit turns off both of the other power-supply-side drive transistor and the other ground-side drive transistor to flow the regenerative current.

Preferably, the one and other power-supply-side drive transistors are P-type MOS transistors, and the one and other ground-side drive transistors are N-type MOS transistors.

Preferably, the drive current detecting unit is a resistance element having a terminal coupled to the power supply potential.

More preferably, the one and other power-supply-side drive transistors are P-type MOS transistors, and the one and other ground-side drive transistors are N-type MOS transistors.

According to another aspect of the present invention, there is provided a motor drive circuit controlling a torque of a motor by flowing, through a coil, a drive current increasing gradually and a regenerative current decreasing gradually in accordance with an inputted torque control voltage to flow through a coil, including a plurality of pairs of a power-supply-side drive transistor and a ground-side drive transistor, a drive current detecting unit and a control circuit. The plurality of pairs of the power-supply-side drive transistor and the ground-side drive transistor are connected in series between a power supply potential and a ground potential, and drive the coil connected at a midpoint. The drive current detecting unit detects the drive current of the coil on the ground side. In the case where the motor is activated to be rotated at a constant speed in a positive direction, the control circuit turns on one power-supply-side drive transistor and one ground-side drive transistor selected from the plurality of pairs of the power-supply-side drive transistor and the ground-side drive transistor to flow the drive current and thereby apply the torque in the positive direction. When the drive current becomes a value corresponding to the torque control voltage, the control circuit turns off the one ground-side drive transistor and turns on the power-supply-side drive transistor paired with the one ground-side drive transistor to flow the regenerative current. In the case where the motor rotating in the positive direction is braked, the control circuit turns on the other power-supply-side drive transistor and the other ground-side drive transistor selected from the plurality of pairs of the power-supply-side drive transistor and the ground-side drive transistor to flow the drive current and thereby apply the torque in a negative direction. When the drive current becomes a value corresponding to the torque control voltage, the control circuit turns off both of the other power-supply-side drive transistor and the other ground-side drive transistor to flow the regenerative current.

Preferably, the one and other power-supply-side drive transistors are P-type MOS transistors, and the one and other ground-side drive transistors are N-type MOS transistors.

Preferably, the drive current detecting unit is a resistance element having a terminal coupled to the ground potential.

More preferably, the one and other power-supply-side drive transistors are P-type MOS transistors, and the one and other ground-side drive transistors are N-type MOS transistors.

According to still another aspect of the present invention, there is provided a motor apparatus, including a motor having a coil, and a motor drive circuit driving the coil. The motor drive circuit controls a torque of the motor by flowing, through a coil, a drive current increasing gradually and a regenerative current decreasing gradually in accordance with an inputted torque control voltage. The motor drive circuit includes a plurality of pairs of a power-supply-side drive transistor and a ground-side drive transistor, a drive current detecting unit, and a control circuit. The plurality of pairs of the power-supply-side drive transistor and the ground-side drive transistor are connected in series between a power supply potential and a ground potential, and drive the coil connected at a midpoint. The drive current detecting unit detects the drive current of the coil on the power supply side. In the case where the motor is activated to be rotated at a constant speed in a positive direction, the control circuit turns on one power-supply-side drive transistor and one ground-side drive transistor selected from the plurality of pairs of the power-supply-side drive transistor and the ground-side drive transistor to flow the drive current and thereby apply the torque in the positive direction. When the drive current becomes a value corresponding to the torque control voltage, the control circuit turns off the one power-supply-side drive transistor and turns on the ground-side drive transistor paired with the one power-supply-side drive transistor to flow the regenerative current. In the case where the motor rotating in the positive direction is braked, the control circuit turns on the other power-supply-side drive transistor and the other ground-side drive transistor selected from the plurality of pairs of the power-supply-side drive transistor and the ground-side drive transistor to flow the drive current and thereby apply the torque in a negative direction. When the drive current becomes a value corresponding to the torque control voltage, the control circuit turns off both of the other power-supply-side drive transistor and the other ground-side drive transistor to flow the regenerative current.

Preferably, the one and other power-supply-side drive transistors are P-type MOS transistors, and the one and other ground-side drive transistors are N-type MOS transistors.

Preferably, the drive current detecting unit is a resistance element having a terminal coupled to the power supply potential.

More preferably, the one and other power-supply-side drive transistors are P-type MOS transistors, and the one and other ground-side drive transistors are N-type MOS transistors.

According to still another aspect of the present invention, there is provided a motor apparatus including a motor having a coil, and a motor drive circuit driving the coil. The motor drive circuit controls a torque of the motor by flowing, through a coil, a drive current increasing gradually and a regenerative current decreasing gradually in accordance with an inputted torque control voltage. The motor drive circuit includes a plurality of pairs of a power-supply-side drive transistor and a ground-side drive transistor, a drive current detecting unit, and a control circuit. The plurality of pairs of the power-supply-side drive transistor and the ground-side drive transistor are connected in series between a power supply potential and a ground potential, and drive the coil connected at a midpoint. The drive current detecting unit detects the drive current of the coil on the ground side. In the case where the motor is activated to be rotated at a constant speed in a positive direction, the control circuit turns on one power-supply-side drive transistor and one ground-side drive transistor selected from the plurality of pairs of the power-supply-side drive transistor and the ground-side drive transistor to flow the drive current and thereby apply the torque in the positive direction. When the drive current becomes a value corresponding to the torque control voltage, the control circuit turns off the one ground-side drive transistor and turns on the power-supply-side drive transistor paired with the one ground-side drive transistor to flow the regenerative current. In the case where the motor rotating in the positive direction is braked, the control circuit turns on the other power-supply-side drive transistor and the other ground-side drive transistor selected from the plurality of pairs of the power-supply-side drive transistor and the ground-side drive transistor to flow the drive current and thereby apply the torque in a negative direction. When the drive current becomes a value corresponding to the torque control voltage, the control circuit turns off both of the other power-supply-side drive transistor and the other ground-side drive transistor to flow the regenerative current.

Preferably, the one and other power-supply-side drive transistors are P-type MOS transistors, and the one and other ground-side drive transistors are N-type MOS transistors.

Preferably, the drive current detecting unit is a resistance element having a terminal coupled to the ground potential.

More preferably, the one and other power-supply-side drive transistors are P-type MOS transistors, and the one and other ground-side drive transistors are N-type MOS transistors.

### EFFECTS OF THE INVENTION

The motor drive circuit according to the present invention can control the torque of the motor, because in the case where the torque in the negative direction is applied to the motor rotating at the constant speed in the positive direction to brake, the power-supply-side drive transistor and the ground-side drive transistor, which are turned on in the drive period TD, are both turned off in the regenerative period TE to reduce the regenerative current, and the drive current is controlled in drive period TD. Moreover, the motor apparatus according to the present invention, including this motor drive circuit, is capable of shortening the time required for reaching another desired rotary speed of the motor.

### BRIEF DESCRIPTION OF THE DRAWINGS

FIG. 1 is a circuit diagram showing a motor apparatus of one embodiment of the present invention.

FIG. 2A is a diagram showing on/off states of drive transistors 15 to 18 in drive period TD.

FIG. 2B is a diagram showing voltage distribution of respective components of a coil 9 in drive period TD.

FIG. 2C is a diagram showing on/off states of the drive transistors 15 to 18 in regenerative period TE.

FIG. 2D is a diagram showing voltage distribution of the respective components of coil 9 in regenerative period TE.

FIG. 2E is a chart showing voltages or current waveforms of respective signals in FIGS. 2A to 2D.

FIG. 3A is a diagram showing on/off states of drive transistors 15 to 18 in drive period TD in the case where motor 2 is braked.

FIG. 3B is a diagram showing voltage distribution of the respective components of coil 9 in drive period TD in the case where motor 2 is braked.

FIG. 3C is a diagram showing on/off states of drive transistors 15 to 18 in regenerative period TE in the case where motor 2 is braked.

FIG. 3D is a diagram showing voltage distribution of the respective components of coil 9 in regenerative period TE in the case where motor 2 is braked.

FIG. 3E is a chart showing voltages or current waveforms of respective signals in FIGS. 3A to 3D in the case where motor 2 is braked.

FIG. 4 is a circuit diagram showing one example of a conventional motor apparatus.

FIG. 5A is a diagram showing on/off states of drive transistors 115 to 118 in drive period TD.

FIG. 5B is a diagram showing voltage distribution of respective components of coil 109 in drive period TD.

FIG. 5C is a diagram showing on/off states of drive transistors 115 to 118 in regenerative period TE.

FIG. 5D is a diagram showing voltage distribution of the respective components of the coil in regenerative period TE.

FIG. 5E is a chart showing voltages or current waveforms of respective signals in FIGS. 5A to 5D.

FIG. 6 is a circuit diagram showing another example of a motor apparatus of an embodiment of the present invention.

### DESCRIPTION OF THE REFERENCE SIGNS

1: motor apparatus, 2: motor, 3: motor drive circuit, 9: coil, 15 and 16: power-supply-side drive transistors, 17 and 18: ground-side drive transistors, 19: resistance element (drive current detecting unit), and 20: control circuit.

### BEST MODES FOR CARRYING OUT THE INVENTION

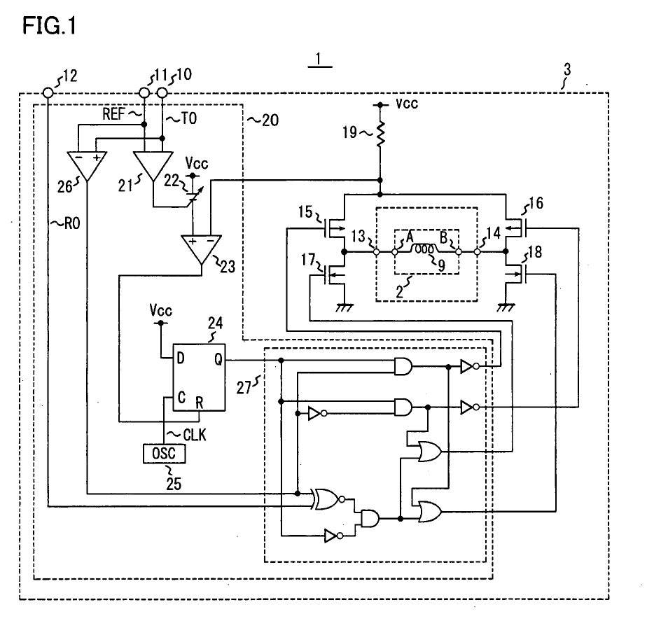

Hereinafter, with reference to the drawings, the best mode of the present invention is described. FIG. 1 is a circuit diagram showing a motor apparatus of an embodiment of the present invention. This motor apparatus 1 has a motor 2 having a coil 9, and a motor drive circuit 3 that drives it. Motor 2 has drive input terminals A, B, and coil 9 is connected between them. Motor drive circuit 3 has a torque-control-voltage input terminal 10 to which torque control voltage TO is inputted, a reference-voltage input terminal 11 to which reference voltage REF of torque control voltage TO is inputted, a rotation-direction-signal input terminal 12 to which a rotation direction signal RO is inputted, a drive output terminal 13 connected to drive input terminal A of motor 2, and a drive output terminal 14 connected to drive input terminal B of motor 2. Although not shown in the figure, torque control voltage TO, reference voltage REF, and rotation direction signal RO are inputted from an instructing unit such as an external microcomputer or the like that controls the entire system through torque-control-voltage input terminal 10, reference-voltage input terminal 11, and rotation-direction-signal input terminal 12, respectively. That is, when the torque in a positive direction is applied to motor 2, torque control voltage TO higher than reference voltage REF is inputted to torque-control-voltage input terminal 10, and when the torque in a negative direction is applied to motor 2, torque control voltage TO lower than reference voltage REF is inputted to the same, respectively. Moreover, when motor 2 is rotating in the positive direction, rotation direction signal RO of high level is inputted, and when it is rotating in the negative direction, rotation direction signal RO of low level is inputted, respectively.

Motor drive circuit 3 further has PMOS-type first and second power-supply-side drive transistors 15, 16, and NMOS-type first and second ground-side drive transistors 17, 18, a resistance element 19 as a drive current detecting unit, and a control circuit 20. First power-supply-side drive transistor 15 and first ground-side drive transistor 17, which make a pair, are connected in series between a power supply potential VCC and a ground potential, and a midpoint thereof is connected to drive output terminal 13. Second power-supply-side drive transistor 16 and second ground-side drive transistor 18, which make a pair, are connected in series between power supply potential VCC and the ground potential, and a midpoint thereof is connected to drive output terminal 14. Power supply sides of first and second power-supply-side drive transistors 15, 16 are connected to each other. The resistance element 19, which is the drive current detecting unit, is provided between their connection point and power supply potential VCC.

Next, control circuit 20, which is a major part of motor drive circuit 3, is described. An absolute-value output device 21 is connected to both torque-control-voltage input terminal 10 and reference-voltage input terminal 11. Absolute-value output device 21 outputs an absolute value of a difference between torque control voltage TO and reference voltage REF. A variable voltage generator 22 is connected to an output terminal of absolute-value output device 21. This variable voltage generator 22 outputs a voltage decreased from power supply potential VCC by a variable voltage in accordance with the output voltage of absolute-value output device 21. The output of variable voltage generator 22 is connected to an inverting input terminal of a drive-current detection comparator 23. One end of resistance element 19 is connected to a non-inverting input terminal of drive-current detection comparator 23. Drive-current detection comparator 23 compares the variable voltage of variable voltage generator 22 and a voltage generated in resistance element 19 to output a signal of low level or high level. A reset input terminal R of a flip-flop 24 is connected to an output terminal of drive-current detection comparator 23. Power supply potential VCC is inputted to a data input terminal D of flip-flop 24. Clock CLK of a constant frequency outputted by an oscillator 25 is inputted to a clock input terminal C. Flip-flop 24 enters a set state by receiving the power supply potential from data input terminal D at the rise of clock CLK, and outputs a signal of high level from an output terminal Q. When the output of drive-current detection comparator 23 becomes a high level, flip-flop 24 enters a reset state, and outputs a signal of low level from output terminal Q.

Moreover, a non-inverting input terminal and an inverting input terminal of a polarity comparator 26 are connected to torque-control-voltage input terminal 10 and reference-voltage input terminal 11, respectively. Polarity comparator 26 compares torque control voltage TO and reference voltage REF to output a signal of high level or low level. A control logic circuit 27 is connected to an output terminal of the aforementioned flip-flop 24, an output terminal of polarity comparator 26, and rotation-direction-signal input terminal 12. The aforementioned first and second power-supply-side drive transistor 15, 16, and first and second ground-side drive transistors 17, 18 are connected to control logic circuit 27. Control logic circuit 27 is made up by combining an AND circuit, an OR circuit, an inverter, and an ENOR circuit. Control logic circuit 27 controls on /off of first and second power-supply-side drive transistors 15, 16, and first and second ground-side drive transistors 17, 18. The operation of this control logic circuit 27 is described next.

When the output of polarity comparator 26 is a high level, control logic circuit 27 operates as follows. The case where the output of polarity comparator 26 is a high level indicates a case where motor 2 is activated to be rotated at the constant speed in the positive direction, as described later, and a case where motor 2 rotating in the negative direction is braked, whose detailed description is omitted. When the output of flip-flop 24 is a high level, control logic circuit 27 turns on first power-supply-side drive transistor 15 and second ground-side drive transistor 18 and turns off second power-supply-side drive transistor 16 and first ground-side drive transistor 17. When the output of flip-flop 24 is a low level and rotation direction signal RO is a high level, control logic circuit 27 turns on first and second ground-side drive transistor 17, 18 and turns off first and second power-supply-side drive transistors 15, 16. When the output of flip-flop 24 is a low level and rotation direction signal RO is a low level, control logic circuit 27 turns off all of first and second power-supply-side drive transistors 15, 16, and first and second ground-side drive transistors 17, 18.

Moreover, when the output of polarity comparator 26 is a low level, control logic circuit 27 operates as follows. The case where the output of polarity comparator 26 is a low level indicates a case where motor 2 rotating in the positive direction is braked, as described later, and a case where motor 2 is activated to be rotated at the constant speed in the negative direction, whose detailed description is omitted. When the output of flip-flop 24 is a high level, control logic circuit 27 turns on second power-supply-side drive transistor 16 and first ground-side drive transistor 17 and turns off first power-supply-side drive transistor 15 and second ground-side drive transistor 18. When the output of flip-flop 24 is a low level and rotation direction signal RO is a low level, control logic circuit 27 turns on first and second ground-side drive transistor 17, 18 and turns off first and second power-supply-side drive transistors 15, 16. When the output of flip-flop 24 is a low level and rotation direction signal RO is a high level, control logic circuit 27 turns off all of first and second power-supply-side drive transistors 15, 16, and first and second ground-side drive transistors 17, 18.

There is needed a circuit that prevents a through current from flowing when transiently, first power-supply-side drive transistor 15 and first ground-side drive transistor 17, or second power-supply-side drive transistor 16 and second ground-side drive transistor 18 are turned on simultaneously. However, a detailed description of this circuit is omitted because it does not relate to the gist of the present invention.

Next, the operation of entire motor apparatus 1 is described. When motor 2 is activated to be rotated at the constant speed in the positive direction, torque control voltage TO higher than reference voltage REF is inputted. A signal of high level is inputted to rotation-direction-signal input terminal 12. This brings the output of polarity comparator 26 to a high level, so that second power-supply-side drive transistor 16 is turned off through control logic circuit 27. Then, when clock CLK from oscillator (OSC) 25 rises, and the output of flip-flop 24 becomes a high level, first ground-side drive transistor 17 is turned off, and first power-supply-side drive transistor 15 and second ground-side drive transistor 18 are turned on. Drive current I_{D} flows from drive input terminal A toward drive input terminal B in coil 9 of motor 2. Drive current I_{D} gradually increases. In resistance element 19, a voltage in proportion to this drive current I_{D} is generated. When this voltage becomes larger than the variable voltage of variable voltage generator 22, the output of the drive-current detection comparator 23 becomes a high level, and the output of the flip-flop 24 becomes a low level. Consequently, first power-supply-side drive transistor 15 is turned off and first ground-side drive transistor 17 is turned on. Regenerative current I_{E} flows from drive input terminal A to drive input terminal B in coil 9. Regenerative current I_{E} gradually decreases.

In this manner, drive current I_{D} increasing gradually and regenerative current I_{E} decreasing gradually repeatedly flow in the direction from drive input terminal A to drive input terminal B, and a maximum value of drive current I_{D} is controlled by torque control voltage TO, so that the torque of motor 2 is controlled.

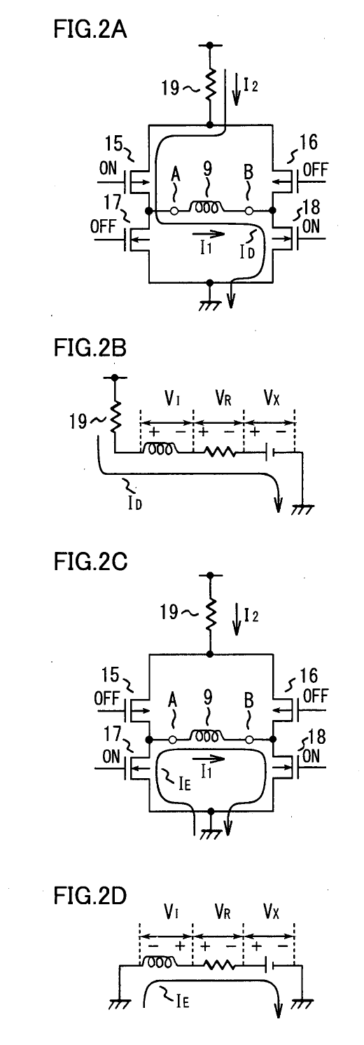

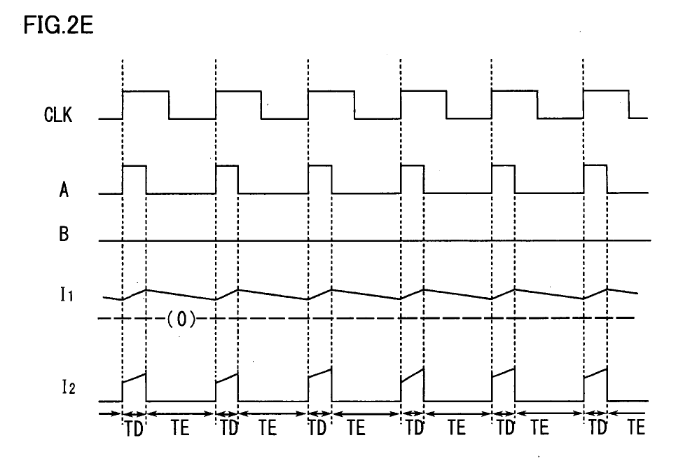

Next, drive current I_{D} and regenerative current I_{E} in coil 9 are further described in detail, based on FIGS. 2A to 2E. FIGS. 2A, 2C are diagrams showing on/off states of drive transistors 15 to 18 in drive period TD, and in regenerative period TE, respectively, FIGS. 2B, 2D are diagrams showing voltage distribution of respective components of coil 9 in drive period TD and regenerative period TE, respectively, and FIG. 2E is a chart showing voltages or current waveforms of respective signals of FIGS. 2A to 2D. CLK indicates a voltage of clock CLK from oscillator 25, A, B indicate voltages of drive input terminals A, B, and with the direction from drive input terminal A to drive input terminal B defined as positive, I₁ indicates a current flowing in coil 9 (that is, a current obtained by adding drive current ID and regenerative current IE) and I₂ indicates a current flowing in resistance element 19. In drive period TD, first power-supply-side drive transistor 15 and second ground-side drive transistor 18 are turned on, and the voltage of drive input terminal A becomes higher than the voltage of drive input terminal B. In coil 9, drive current I_{D} flows from drive input terminal A toward drive input terminal B. As a result, the torque in the positive direction is applied to motor 2. At this time, as shown in FIG. 2B, counter electromotive voltage Vₓ by rotation is generated in the opposite direction of drive current I_{D}, that is, from drive input terminal B toward drive input terminal A.

In regenerative period TE, since first power-supply-side drive transistor 15 is turned off, and first ground-side drive transistor 17 is turned on, both of drive input terminals A, B almost reach the ground potential, and are substantially shorted. At this time, as shown in FIGS. 2C and 2D, in coil 9, regenerative current I_{E} flows from drive input terminal A to drive input terminal B, counter electromotive voltage Vₓ by rotation is generated in the opposite direction of regenerative current I_{E} as in drive period TD.

Subsequently, the case where motor 2 rotating in the positive direction is braked is described. In this case, torque control voltage TO lower than reference voltage REF is inputted. As a result, second power-supply-side drive transistor 15 is turned off. Then, when clock CLK rises, and the output of flip-flop 24 becomes a high level, second ground-side drive transistor 18 is turned off, and second power-supply-side drive transistor 16 and first ground-side drive transistor 17 are turned on. Drive current I_{D} flows in the direction from drive input terminal B to drive input terminal A (in the negative direction) in coil 9. Drive current I_{D} gradually increases. A voltage in proportion to this drive current I_{D} is generated in resistance element 19. When this voltage becomes larger than the variable voltage of variable voltage generator 22, the output of the drive-current detection comparator 23 becomes a high level, and the output of the flip-flop 24 becomes a low level. Consequently, second power-supply-side drive transistor 16 and first ground-side drive transistor 17 are turned off, so that regenerative current I_{E} flows from drive input terminal B to drive input terminal A in coil 9. Regenerative current I_{E} gradually decreases until clock CLK rises again.

In this manner, drive current I_{D} increasing gradually and regenerative current I_{E} decreasing gradually repeatedly flow in the direction from drive input terminal B to drive input terminal A, and a negative maximum value of drive current I_{D} is controlled by torque control voltage TO, by which the torque of motor 2 is controlled.

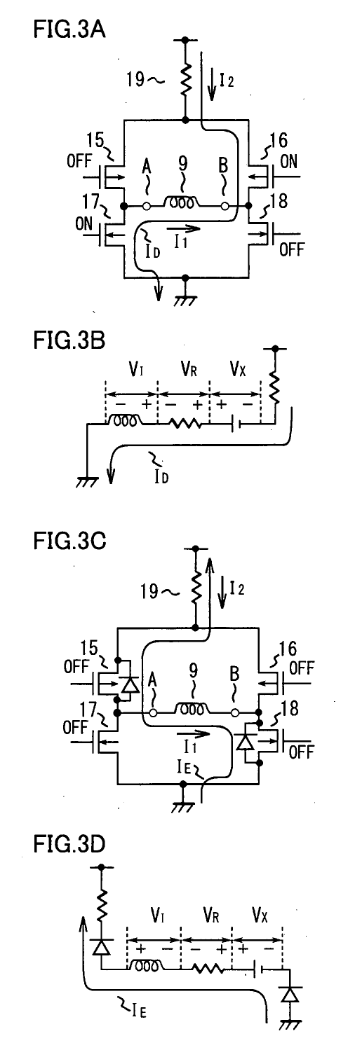

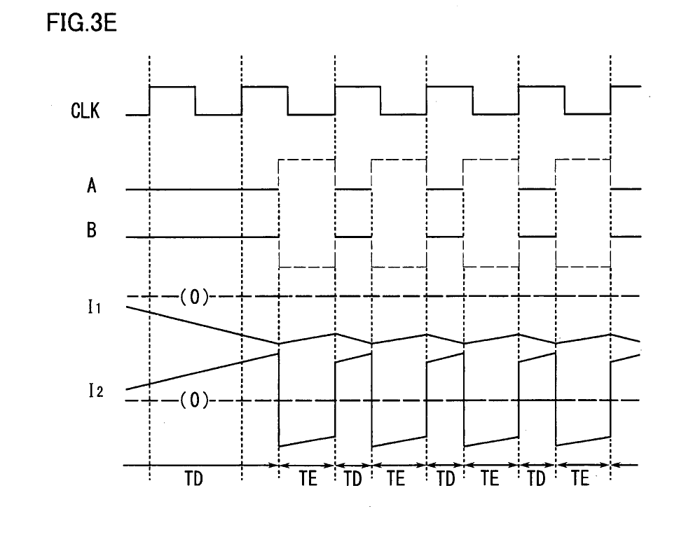

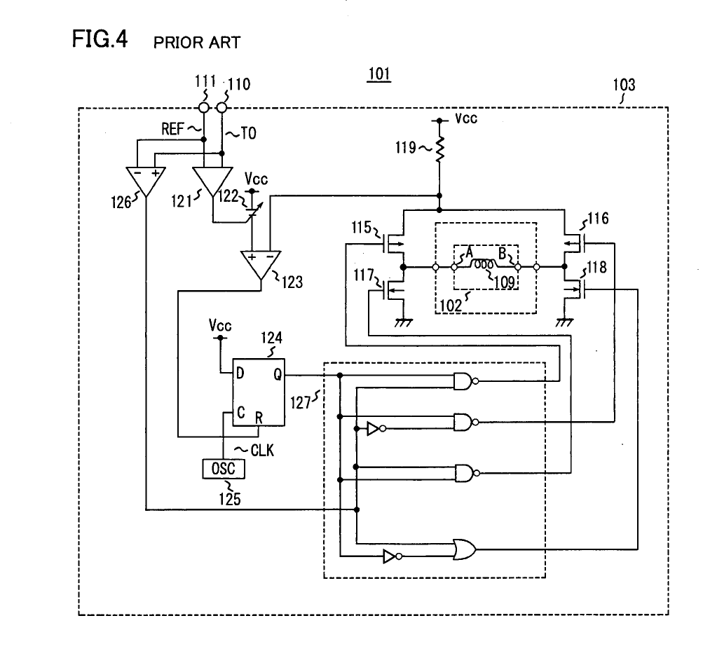

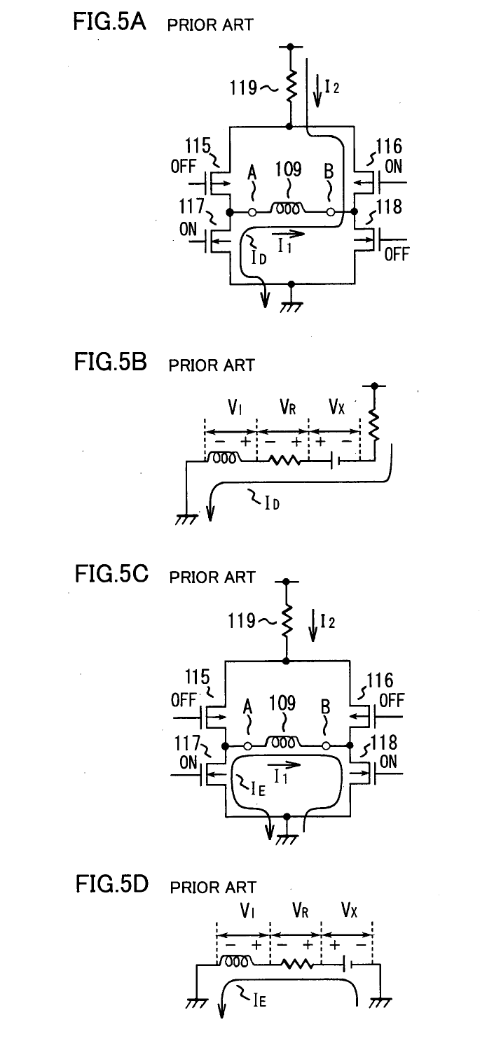

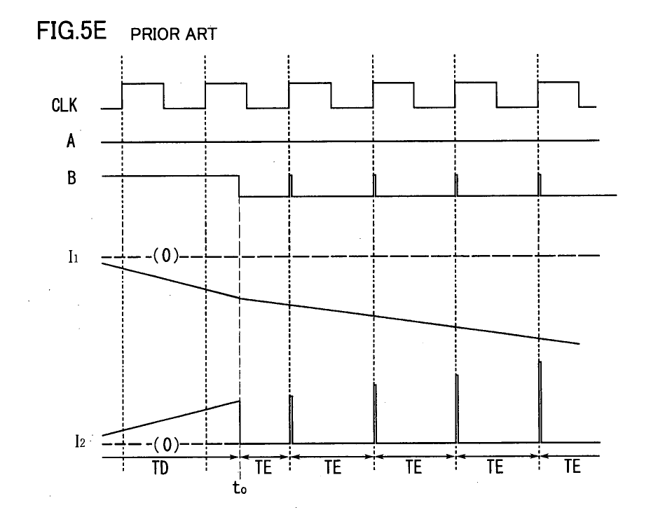

Furthermore, drive current I_{D} and regenerative current I_{E} of coil 9 when motor 2 is braked are described in detail, based on FIGS. 3A to 3E. The contents of FIGS. 3A to 3E correspond to FIGS. 2A to 2E, respectively. In drive period TD, second power-supply-side drive transistor 16 and first ground-side drive transistor 17 are turned on, and the voltage of drive input terminal B becomes higher than the voltage of drive input terminal A. In coil 9, drive current I_{D} flows from drive input terminal B toward drive input terminal A. As a result, motor 2 is decelerated by the torque in the negative direction. Full one cycle of clock CLK until drive current I_{D} reaches the negative maximum value becomes drive period TD, and thereafter, drive period TD and regenerative period TE are repeated.

As shown in FIG. 3E, in regenerative period TE, regenerative current I_{E} flows from the ground potential to power supply potential VCC through a parasitic diode existing in parallel with NMOS-type second ground-side drive transistor 18, drive input terminal B, coil 9, drive input terminal A, and a parasitic diode existing in parallel with PMOS-type first power-supply-side drive transistor 15. At this time, as shown in FIG. 3D, counter electromotive voltage Vₓ by rotation is generated in the same direction as regenerative current I_{E} (direction from drive input terminal B to drive input terminal A), and voltage V_{R} by the resistance component is generated in the opposite direction of regenerative current I_{E}. Moreover, since a counter electromotive voltage V₁ by an inductance component should be generated in the same direction as regenerative current I_{E}, regenerative current I_{E} will gradually decrease. In regenerative period TE, if the voltage drop of resistance element 19 is ignored, drive input terminal A has a voltage increasing from power supply voltage VCC by a forward bias voltage (Vf) of the parasitic diode, and drive input terminal B has a voltage decreasing from the ground potential by the forward bias voltage (Vf) of the parasitic diode.

Accordingly, since after drive current I_{D} of drive period TD becomes a maximum value, regenerative current I_{E} decreases, the torque of motor 2 can be controlled. Thus, even when motor 2 rotating in the positive direction is braked, by controlling the maximum value of drive current I_{D} by torque control voltage TO, a desired torque in the negative direction is applied to motor 2. As a result, motor 2 is decelerated and a time until another desired rotary speed is reached can be shortened.

In this motor drive circuit 3, in the case where motor 2 rotating in the positive direction is braked, drive transistors 15, 17, 16, 18 are all turned off by turning off second power-supply-side drive transistor 16 and first ground-side drive transistor 17. However, power consumption by the parasitic diode can be reduced in some degree by turning on second ground-side drive transistor 18.

Both operations when motor 2 is activated to be rotated at a constant speed in the negative direction and when motor 2 rotating in the negative direction is braked are obvious from the above descriptions, whose detailed descriptions are omitted.

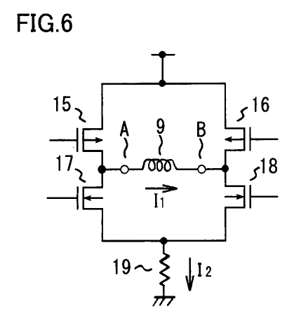

Moreover, while in motor apparatus 1 as described above, resistance element 19 is provided as the drive current detecting unit on the power supply side, a modification can be also made such that the resistance element is provided as the drive current detecting unit not on the power supply side but on the ground side, as shown in FIG. 6. In this case, in order to activate the motor to rotate at a constant speed in the positive direction, after the drive current becomes a value corresponding to the torque control voltage, second ground-side drive transistor is turned off, and second power-supply-side drive transistor is turned on, by which the regenerative current flows. Additionally, while small changes to correspond to this modification are necessary with respect to variable voltage generator 22, drive-current detection comparator 23 and the like, they are obvious, and their descriptions are omitted.

Moreover, as described in the description of the background art, utilizing an on-resistance of the power-supply-side drive transistor or the ground-side drive transistor, or the like also makes it possible not to use the resistance element as the drive current detecting unit.

As described above, while the motor drive circuit and the motor apparatus including it, which are the embodiments of the present invention, are described, the present invention is not limited to those described in the embodiments, but various design changes can be made within the range of items described in the claims. For example, the power-supply-side drive transistors can also be changed to NMOS-type transistors, or all or a part of the drive transistors can also be changed to bipolar type transistors. In this case, when the parasitic diodes as shown in the embodiments do not exist, these can also be provided separately. Also, the present invention is applicable in the case where a motor having a plurality of coils (for example, three-phase motor) is driven. Moreover, it goes without saying that the control circuit can have an arbitrary configuration as long as it makes the drive transistors perform the operation as shown in the embodiments.

It should be considered that the embodiments disclosed herein are illustrative, not limitative in any point. It is intended that the scope of the present invention is indicated not by the above descriptions but by the claims, and that meaning equivalent to the claims and all changes within the scope are included.

1. A motor drive circuit controlling a torque of a motor by flowing, through a coil, a drive current increasing gradually and a regenerative current decreasing gradually in accordance with an inputted torque control voltage, comprising: a plurality of pairs of a power-supply-side drive transistor and a ground-side drive transistor connected in series between a power supply potential and a ground potential, and driving said coil connected at a midpoint;
a drive current detecting unit detecting the drive current of said coil on the power supply side; and
a control circuit turning on, in the case where said motor is activated to be rotated at a constant speed in a positive direction, one power-supply-side drive transistor and one ground-side drive transistor t selected from said plurality of pairs of the power-supply-side drive transistor and the ground-side drive transistor to flow said drive current and thereby apply the torque in the positive direction, and when said drive current becomes a value corresponding to said torque control voltage, turning off said one power-supply-side drive transistor M and turning on the ground-side drive transistor paired with said one power-supply-side drive transistor to flow the regenerative current, and in the case where said motor rotating in the positive direction is braked, turning on the other power-supply-side drive transistor and the other ground-side drive transistor ( selected from said plurality of pairs of the power-supply-side drive transistor and the ground-side drive transistor to flow said drive current and thereby apply the torque in the positive direction, and when said drive current becomes a value corresponding to said torque control voltage, turning off both of said other power-supply-side drive transistor 3 and said other ground-side drive transistor to flow said regenerative current.

2. The motor drive circuit according to claim 1, wherein said one and other power-supply-side drive transistors are P-type MOS transistors, and
said one and other ground-side drive transistors are N-type MOS transistors.

3. The motor drive circuit according to claim 1, wherein said drive current detecting unit is a resistance element having a terminal coupled to said power supply potential.

4. The motor drive circuit according to claim 3, wherein said one and other power-supply-side drive transistors are P-type MOS transistors, and said one and other ground-side drive transistors are N-type MOS transistors.

5. A motor drive circuit controlling a torque of a motor by flowing, through a coil, a drive current increasing gradually and a regenerative current decreasing gradually in accordance with an inputted torque control voltage, comprising:
a plurality of pairs of a power-supply-side drive transistor and a ground-side drive transistor connected in series between a power supply potential and a ground potential, and driving said coil connected at a midpoint;
a drive current detecting unit detecting the drive current of said coil on the ground side; and
a control circuit turning on, in the case where said motor is activated to be rotated at a constant speed in a positive direction, one power-supply-side drive transistor and one ground-side drive transistor v selected from said plurality of pairs of the power-supply-side drive transistor and the ground-side drive transistor to flow said drive current and thereby apply the torque in the positive direction, and when said drive current becomes a value corresponding to said torque control voltage, turning off said one ground-side drive transistor and turning on the power-supply-side drive transistor paired with said one ground-side drive transistor v to flow the regenerative current, and in the case where said motor rotating in the positive direction is braked, turning on the other power-supply-side drive transistor and the other ground-side drive transistor selected from said plurality of pairs of the power-supply-side drive transistor and the ground-side drive transistor to flow said drive current and thereby apply the torque in a negative direction, and when said drive current becomes a value corresponding to said torque control voltage, turning off both of said other power-supply-side drive transistor and said other ground-side drive transistor to flow said regenerative current.

6. The motor drive circuit according to claim 5, wherein said one and other power-supply-side drive transistors are P-type MOS transistors, and said one and other ground-side drive transistors are N-type MOS transistors.

7. The motor drive circuit according to claim 5, wherein said drive current detecting unit is a resistance element having a terminal coupled to said ground potential.

8. The motor drive circuit according to claim 7, wherein said one and other power-supply-side drive transistors are P-type MOS transistors, and
said one and other ground-side drive transistors are N-type MOS transistors.

9. A motor apparatus comprising:
a motor having a coil; and
a motor drive circuit driving said coil,
wherein said motor drive circuit controls a torque of said motor by flowing, through a coil, a drive current increasing gradually and a regenerative current decreasing gradually in accordance with an inputted torque control voltage, said motor drive circuit includes:
a plurality of pairs of a power-supply-side drive transistor and a ground-side drive transistor connected in series between a power supply potential and a ground potential, and driving said coil connected at a midpoint;
a drive current detecting unit detecting the drive current of said coil on the power supply side; and
a control circuit turning on, in the case where said motor is activated to be rotated at a constant speed in a positive direction, one power-supply-side drive transistor and one ground-side drive transistor selected from said plurality of pairs of the power-supply-side drive transistor and the ground-side drive transistor to flow said drive current and thereby apply the torque in the positive direction, and when said drive current becomes a value corresponding to said torque control voltage, turning off said one power-supply-side drive transistor and turning on the ground-side drive transistor paired with said one power-supply-side drive transistor to flow the regenerative current and in the case where said motor rotating in the positive direction is braked, turning on the other power-supply-side drive transistor and the other ground-side drive transistor selected from said plurality of pairs of the power-supply-side drive transistor and the ground-side drive transistor to flow said drive current and thereby apply the torque in a negative direction, and when said drive current becomes a value corresponding to said torque control voltage, turning off both of said other power-supply-side drive transistor and said other ground-side drive transistor e to flow said regenerative current.

10. The motor apparatus according to claim 9, wherein said one and other power-supply-side drive transistors are P-type MOS transistors, and
said one and other ground-side drive transistors are N-type MOS transistors.

11. The motor apparatus according to claim 9, wherein said drive current detecting unit is a resistance element having a terminal coupled to said power supply potential.

12. The motor apparatus according to claim 11, wherein said one and other power-supply-side drive transistors are P-type MOS transistors, and
said one and other ground-side drive transistors are N-type MOS transistors.

13. A motor apparatus comprising:
a motor having a coil; and
a motor drive circuit driving said coil,
wherein said motor drive circuit controls a torque of said motor by flowing, through a coil, a drive current increasing gradually and a regenerative current decreasing gradually in accordance with an inputted torque control voltage, said motor drive circuit includes:
a plurality of pairs of a power-supply-side drive transistor and a ground-side drive transistor connected in series between a power supply potential and a ground potential, and driving said coil connected at a midpoint;
a drive current detecting unit detecting the drive current of said coil on the ground side; and
a control circuit turning on, in the case where said motor is activated to be rotated at a constant speed in a positive direction, one power-supply-side drive transistor and one ground-side drive transistor selected from said plurality of pairs of the power-supply-side drive transistor and the ground-side drive transistor to flow said drive current and thereby to apply the torque in the positive direction, and when said drive current becomes a value corresponding to said torque control voltage, turning off said one ground-side drive transistor and turning on the power-supply-side drive transistor paired with said one ground-side drive transistor to flow the regenerative current, and in the case where said motor rotating in the positive direction is braked, turning on the other power-supply-side drive transistor and the other ground-side drive transistor selected from said plurality of pairs of the power-supply-side drive transistor and the ground-side drive transistor to flow said drive current and thereby apply the torque in a negative direction, and when said drive current becomes a value corresponding to said torque control voltage, turning off both of said other power-supply-side drive transistor and said other ground-side drive transistor to flow said regenerative current.

14. The motor apparatus according to claim 13, wherein said one and other power-supply-side drive transistors are P-type MOS transistors, and
said one and other ground-side drive transistors are N-type MOS transistors.

15. The motor apparatus according to claim 13, wherein said drive current detecting unit is a resistance element having a terminal coupled to said power supply potential.

16. The motor apparatus according to claim 15, wherein said one and other power-supply-side drive transistors are P-type MOS transistors, and
said one and other ground-side drive transistors are N-type MOS transistors.
